(19) United States
(12) Patent Application Publication
(10) Pub. No.: US 2025/0351954 A1
(43) Pub. Date: Nov. 20, 2025

(54) Asymmetrical Multifunctional Folding Table

(71) Applicant: YIXIANG BLOW MOLDING FURNITURE CO., LTD., Yuyao (CN)

(72) Inventors: Yixiang JIANG, Yuyao (CN); Shangxi JIANG, Yuyao (CN); Jinglei JIANG, Yuyao (CN)

(73) Assignee: YIXIANG BLOW MOLDING FURNITURE CO., LTD., Yuyao (CN)

(21) Appl. No.: 19/200,205

(22) Filed: May 6, 2025

(30) Foreign Application Priority Data
May 17, 2024 (CN) 202410616905.5

(51) Int. Cl. A47B 3/083; A47B 37/04; A47J 37/07

(52) U.S. Cl. CPC A47B 3/083; A47B 37/04; A47J 37/0781; A47J 2037/0777

(57) ABSTRACT

The present subject matter is directed to an asymmetrical and multifunctional folding table, comprising a first tabletop and a second tabletop that are foldable relative to each other. An outer portion of the first tabletop is provided with a functional groove recessed below the top surface of the first tabletop. The functional groove and the first tabletop jointly form a receiving area to store the second tabletop in a folded state of the folding table. The functional groove expands the table's functionality. When folded, the recessed functional groove does not occupy additional packaging volume, allowing for a compact packaging size, which is conducive to reducing packaging costs.

### CROSS-REFERENCES TO RELATED APPLICATIONS

This application claims the priority of CN patent application Ser. No. 20/241,0616905.5, entitled “MULTIFUNCTIONAL FOLDING TABLE,” filed May 17, 2024, which is incorporated herein by reference for all purposes.

### TECHNICAL FIELD

The present subject matter is in the field of furniture design and manufacture. More particularly, embodiments of the present subject matter relate to a multifunctional folding table.

### BACKGROUND

Tables are frequently used in daily life, commonly used to place various everyday items. A table typically includes a tabletop and a support structure for supporting the tabletop. With the support of the structure, the tabletop is maintained in a horizontal position so that items can be steadily placed on the tabletop.

The tabletop of conventional tables is usually flat, with a relatively simple structure and limited functionality, which cannot meet user's diverse needs. In particular, for folding tables, the left and right tabletops are typically symmetrically structured. When folded, the back sides of the two tabletops come close together. This folding structure is suitable when the tabletop is entirely flat. After folding, the table forms a square shape, which makes packaging compact and convenient. However, if the tabletop has a distinct contoured structure—meaning a certain area of the tabletop is recessed or raised—the two tabletops in such folding tables cannot fit together seamlessly when folded, and the folded table cannot form a regular shape, making packaging difficult.

As user's functional requirements for tables continue to increase, some tables are equipped with storage devices under the tabletop, such as drawers, to place items and make use of the space beneath the tabletop. However, existing storage devices for tables have at least the following shortcomings.

First, storage devices such as drawers are often directly or indirectly mounted under the tabletop, making the entire table relatively bulky. Furthermore, to ensure long-term use, most storage devices are made to be sturdy and durable, which also contributes to the table's heaviness.

Second, existing storage devices for tables are often fixed in a preset position. Once the storage device is removed, it leaves a hole on the table, affecting the overall appearance. Additionally, after the storage device is removed from the table, the support for the tabletop is often compromised.

Moreover, after conventional tables are manufactured, their shape and size are permanent and cannot be expanded or adjusted according to different usage needs, resulting in inflexible use. To solve the problem of table expansion, there are also cases where two tables are joined together for use. However, after joining, the two tables tend to slide relative to each other, causing inconvenience during use. Furthermore, the current method of joining two tables allows for only a single fixed configuration, which cannot be flexibly adjusted according to different spaces or locations.

### SUMMARY OF THE SUBJECT MATTER

The technical problem to be solved by the present subject matter is to provide a asymmetrical multifunctional folding table with a recessed storage or functional groove integrally formed on the tabletop, wherein the functional groove does not increase the packaging volume of the folded table.

The technical solution adopted by the present subject matter includes a multifunctional folding table that is not symmetrical, comprising a first table body and a second table body that can be folded relative to each other, the first table body having a first tabletop and a first table frame disposed at the bottom of the first tabletop, and the second table body having a second tabletop and a second table frame disposed at the bottom of the second tabletop.

Furthermore, an outer portion of the first tabletop is provided with a functional storage area recessed below the tabletop surface of the first tabletop, wherein the outer bottom surface of the storage area is lower than the bottom edge of the first tabletop in areas outside the groove, and the bottom of the functional or storage groove and the bottom of the region outside the groove together form a receiving portion for the first table body during folded state.

In particular, in the folded state of the first and second table bodies, the second table body is flipped to the back of the first table body and received within the receiving portion, and the surface of the second tabletop is flush with the outer bottom surface of the storage groove or storage area.

To allow the second tabletop to flip smoothly to the back side of the first tabletop, the length of the second tabletop is equal to the length of the first tabletop excluding the storage groove region, thus rendering the first tabletop longer than the second tabletop.

To reduce the folding volume of the table and conceal the table frame inside the folded tabletop, the edge of the first tabletop outside the storage groove is provided with a first downward flange, the edge of the second tabletop is provided with a second downward flange, the height of the first and second downward flanges is equal, and in the folded state of the first and second table bodies, the first and second downward flanges abut against each other.

According to some embodiments, a heating base can be installed within the storage groove/basket, and a grill plate can be provided on the heating base. During use, the heating base heats the grill plate, allowing food to be heated or kept warm, which is especially suitable for outdoor uses.

According to some embodiments, a cover can be used to cover the storage groove/basket, and a locking limit structure can be provided between the storage groove/basket and the cover. The cover can be positionally limited above the storage groove or stored inside it by the locking limit structure. With this configuration, the cover can enclose items placed in the storage groove/basket to avoid contamination, and can be locked in place to prevent it from falling off the table. Additionally, the cover can provide a heat-insulating function. Beverages, ice packs, or imitation ice can be placed inside the storage groove/basket and covered to achieve insulation.

According to some embodiments, the locking limit structure can be configured in many ways. Preferably, both sides of the cover can be provided with outwardly extending limiting blocks, the corresponding sides of the storage groove are formed with limiting notches, and locking blocks are installed on the outer side of the limiting notches. The limiting blocks can be inserted into the limiting notches and locked in position by the locking blocks.

According to some embodiments, when the cover is placed over the storage groove or is stored inside it with the top of the cover facing downward, the locking blocks are rotated to the outer side of the limiting notches so that their roots abut against the limiting blocks, or are rotated to the inner side of the limiting notches and press down on the limiting blocks. In this way, once the locking blocks are engaged, the cover cannot separate from the table.

According to some embodiments, the sides of the cover are provided with outwardly extending positioning blocks, each positioning block having a positioning hole. The outer side of the storage groove is formed with a limiting notch containing an upwardly extending positioning post. The positioning post is inserted into the positioning hole to position the cover above the storage groove. With this arrangement, the insertion of the positioning post into the positioning hole prevents the cover from detaching from the table.

To give the multifunctional folding table additional storage, a storage rack can be mounted on the outer side of the first and/or second table frame. The storage rack has an expanded state and a folded state. In the expanded state, the storage rack unfolds outward from the table frame and provides storage functionality. In the folded state, the storage rack is placed against the outer side of the table frame.

The addition of a storage rack further enhances the functionality of the table. When using the table, users can place items not only on the tabletop but also on the storage rack. When not in use, the storage rack can be folded and placed close to the table frame, occupying no external space and not affecting the overall appearance of the table.

To allow multiple folding tables to be joined together, a coupling groove is formed on the side of the tabletop of the multifunctional folding table. The coupling grooves on the corresponding sides of two folding tables are brought together and fixedly connected by a coupling member. During coupling, the coupling member is simply inserted into the coupling grooves, enabling firm connection between the two folding tables. During use, the tabletops are not prone to detachment. During disassembly, the coupling member only needs to be pulled out. Coupling and disassembly of the tables are both very convenient.

Compared with the prior designs, the advantages of the present subject matter include: The first and second table bodies of the multifunctional folding table can be folded relative to each other. An outer portion of the first tabletop is provided with a functional groove recessed below the tabletop surface, which enhances the functionality of the folding table, allowing it to be adapted to more usage scenarios such as storage or housing a heating device for food.

Furthermore, the bottom of the storage groove and the bottom of the surrounding area of the first tabletop form a receiving portion. During folding, the second table body is flipped to the back of the first table body and received within the receiving portion, with the surface of the second tabletop flush with the outer bottom surface of the storage groove. As a result, the recessed functional groove does not increase the packaging volume, allowing for a more compact package size and helping to reduce packaging costs.

### DESCRIPTION OF DRAWINGS

The present subject matter is illustrated by way of example, and not by way of limitation, in the figures of the accompanying drawings and in which:

FIG. 1 is a schematic structural view of the asymmetrical multifunctional folding table of Embodiment I of the present subject matter in a usage state;

FIG. 2 is a schematic structural view of the asymmetrical multifunctional folding table shown in FIG. 1 with the table frame in a folded state;

FIG. 3 is a partially exploded schematic view of the asymmetrical multifunctional folding table shown in FIG. 2;

FIG. 4 is a schematic structural view of the asymmetrical multifunctional folding table shown in FIG. 2 from another angle;

FIG. 5 is a schematic structural view of the asymmetrical multifunctional folding table of Embodiment I of the present subject matter in a folded state;

FIG. 6 is a schematic structural view of the folding table shown in FIG. 5 from a different angle;

FIG. 7 is a schematic structural view of the asymmetrical multifunctional folding table of Embodiment II of the present subject matter in a usage state;

FIG. 8 is an enlarged schematic view of portion A in FIG. 7;

FIG. 9 is a partially exploded schematic view of the folding table shown in FIG. 7;

FIG. 10 is a schematic structural view of the asymmetrical multifunctional folding table of Embodiment II of the present subject matter in the stored state of the cover;

FIG. 11 is an enlarged schematic view of portion B in FIG. 10;

FIG. 12 is a partially exploded schematic view of the folding table shown in FIG. 10;

FIG. 13 is a schematic structural view of the asymmetrical multifunctional folding table of Embodiment II of the present subject matter in the stored state of the cover;

FIG. 14 is a schematic structural view of the asymmetrical multifunctional folding table of Embodiment III of the present subject matter in a usage state;

FIG. 15 is a partially exploded schematic view of the folding table shown in FIG. 14;

FIG. 16 is a schematic structural view of the folding table shown in FIG. 14 with the cover placed inside the functional groove;

FIG. 17 is a schematic structural view of two asymmetrical multifunctional folding tables joined together in Embodiment IV of the present subject matter; and

FIG. 18 is a schematic structural view of a single asymmetrical multifunctional folding table in Embodiment IV of the present subject matter.

### DETAILED DESCRIPTION

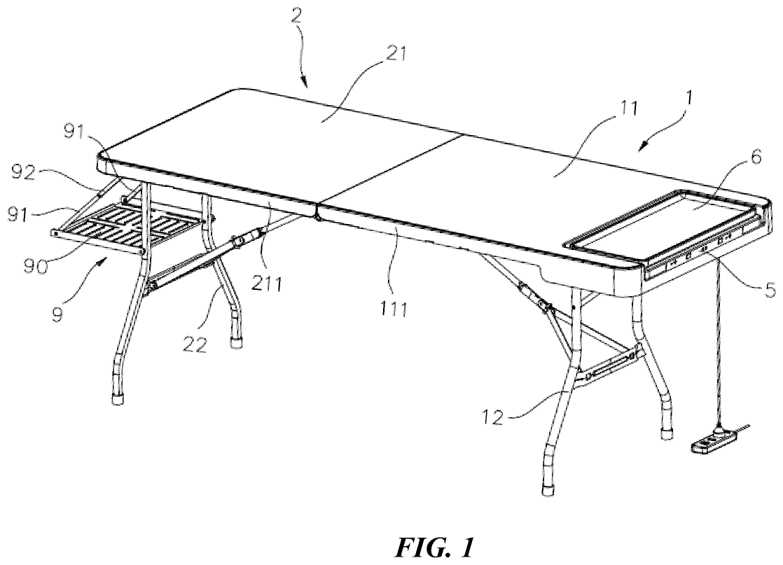

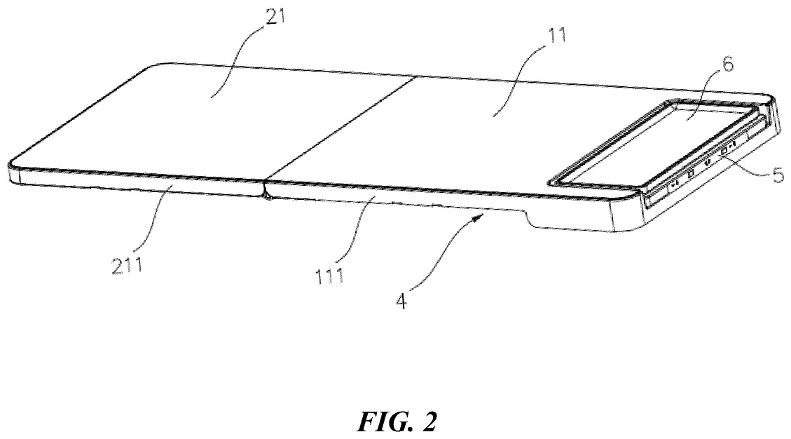

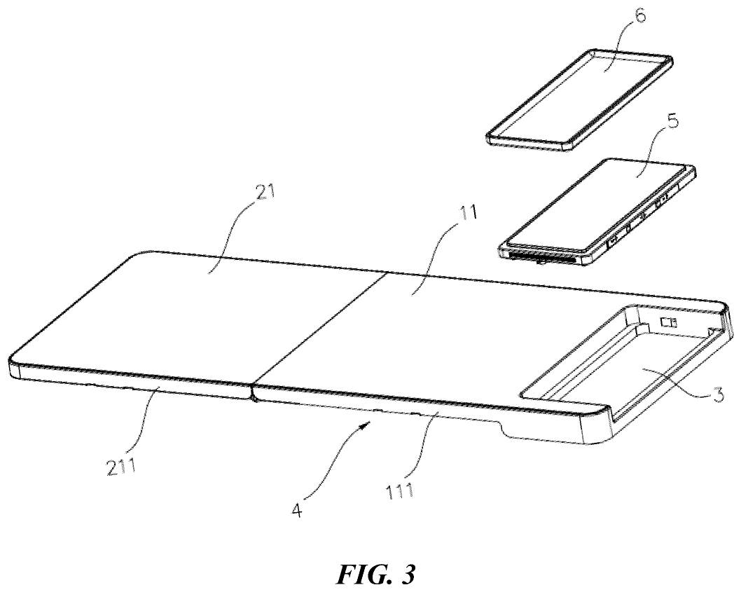

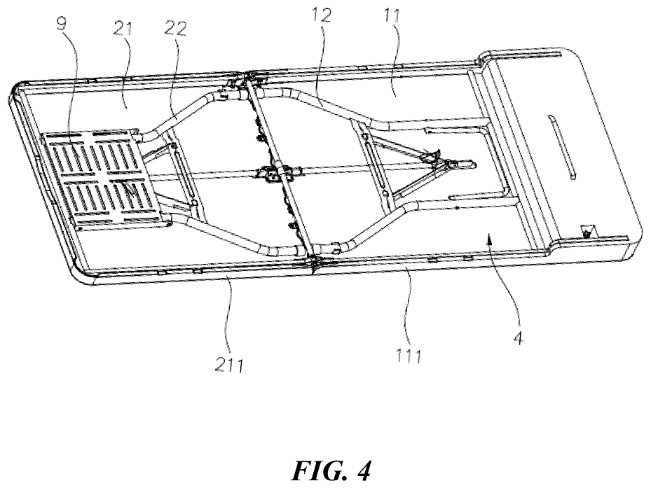

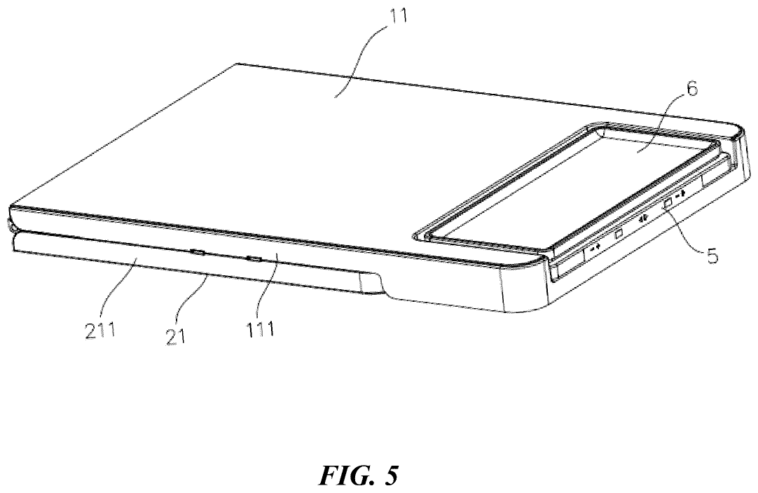

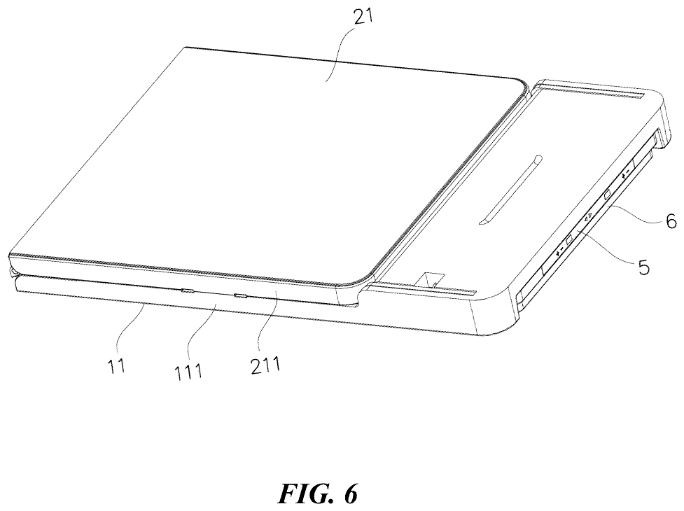

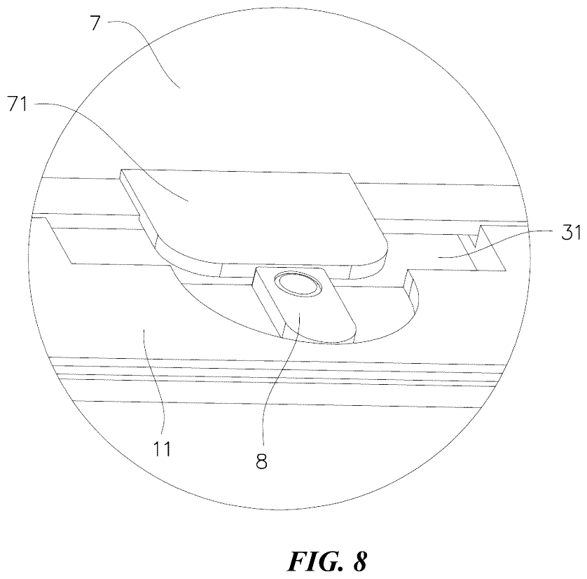

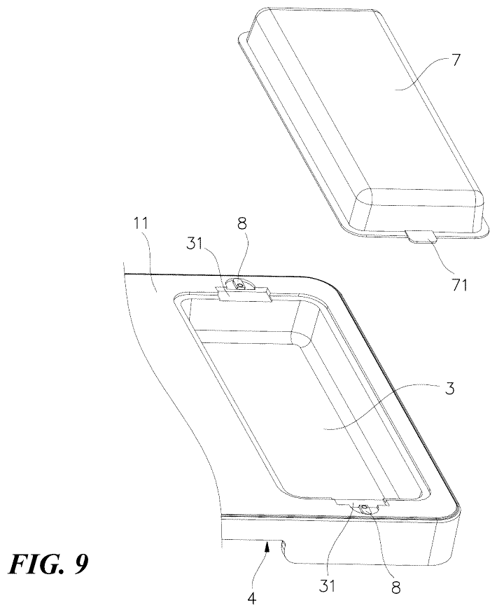

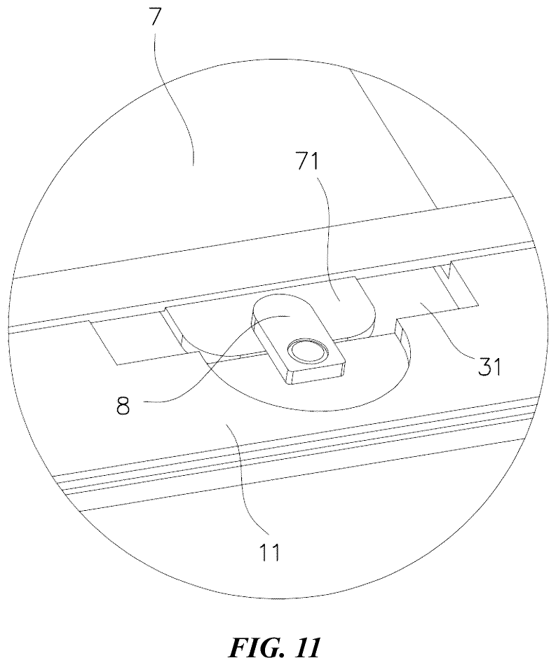

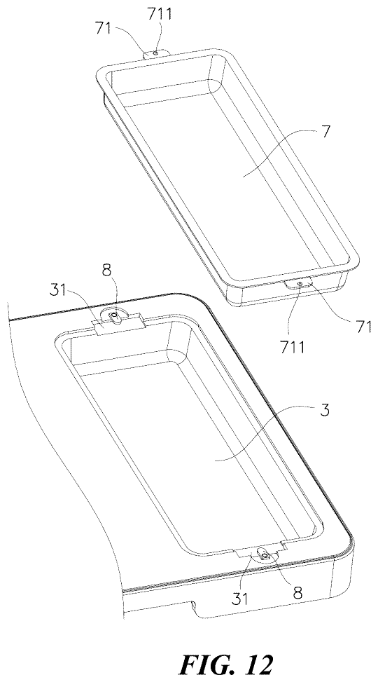

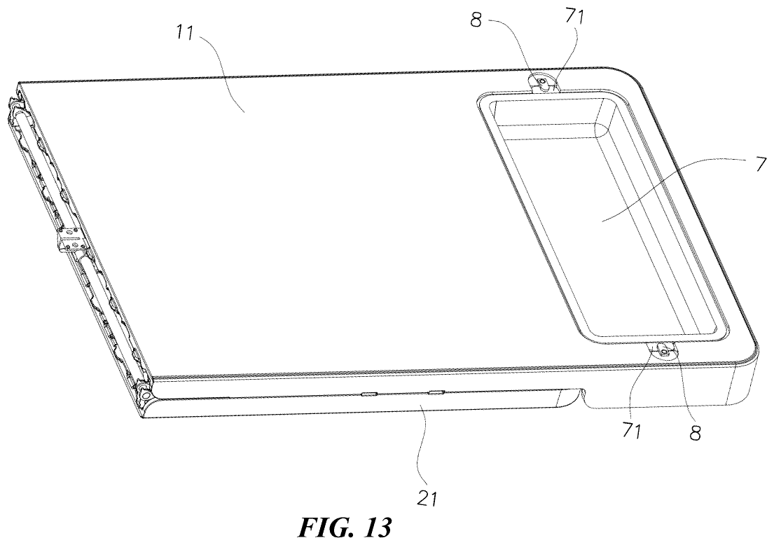

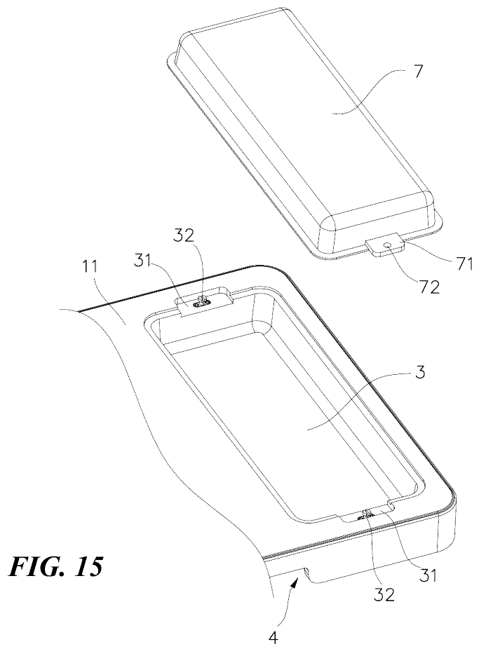

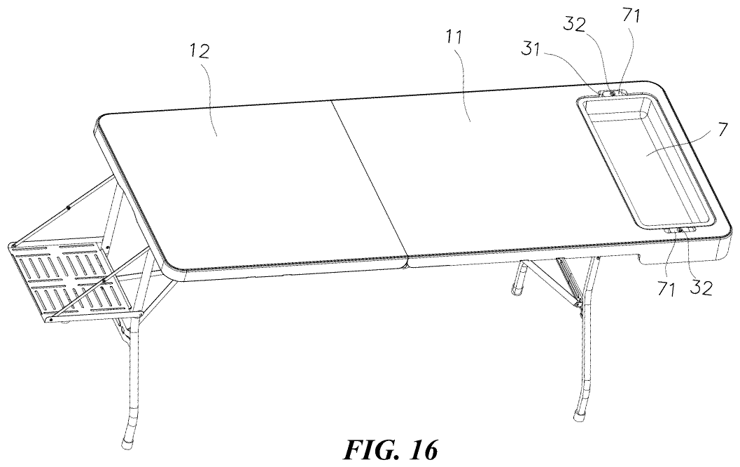

The present subject matter pertains to improved approaches for an asymmetrical multifunctional folding table. Embodiments of the present subject matter are discussed below with reference to FIGS. 1-18.

In the following description, for purposes of explanation, numerous specific details are set forth in order to provide a thorough understanding of the present subject matter. It will be apparent, however, to one skilled in the art that the present subject matter may be practiced without some of these specific details. In addition, the following description provides examples, and the accompanying drawings show various examples for the purposes of illustration. Moreover, these examples should not be construed in a limiting sense as they are merely intended to provide examples of embodiments of the subject matter rather than to provide an exhaustive list of all possible implementations. In other instances, well-known structures and devices are shown in block diagram form in order to avoid obscuring the details of the disclosed features of various described embodiments.

### Embodiment I

As shown in FIGS. 1 to 6, the asymmetrical multifunctional folding table of this embodiment comprises a first table body 1 and a second table body 2 that are foldable with respect to each other. The first table body 1 includes a first tabletop 11 and a first table frame 12 provided at the bottom of the first tabletop 11. The second table body 2 includes a second tabletop 21 and a second table frame 22 provided at the bottom of the second tabletop 21.

An outer portion of the first tabletop 11 is provided with a functional groove 3 recessed below the tabletop surface of the first tabletop 11. The functional groove 3 can serve as a storage area or storage cavity for various items or food. The outer bottom surface of the functional groove 3 is lower than the bottom edge of the first tabletop 11 in regions outside the groove. The bottom of the functional groove 3 and the bottom of the first tabletop 11 in the region outside the groove form a receiving portion 4.

The length of the second tabletop 21 is equal to the length of the first tabletop 11 excluding the region of the functional groove 3, that is, the first tabletop is the larger tabletop, and the second tabletop is the smaller tabletop, rendering the tabletops asymmetrical.

The edge of the first tabletop 11 in the region outside the functional groove 3 is provided with a first downward flange 111, and the edge of the second tabletop 21 is provided with a second downward flange 211. The first downward flange 111 and the second downward flange 211 have the same height.

During folding, first, the first table frame 12 is flipped to the back side of the first tabletop 11, and the second table frame 22 is flipped to the back side of the second tabletop 21, completing the folding of the first table body 1 and the second table body 2. Then, the folded second table body 2 is entirely flipped to the back of the first table body 1. In the folded state of the first and second table bodies, the second table body 2 is flipped to the back of the first table body 1 and received within the receiving portion 4, and the surface of the second tabletop 21 is flush with the outer bottom surface of the functional groove 3. At this state, the first downward flange 111 and the second downward flange 211 are abutted against each other.

After folding, the recessed functional groove does not occupy additional packaging volume, allowing for a more compact packaging size of the folding table and helping to reduce packaging costs.

According to some embodiment, an optional heating base 5 can be installed inside the functional groove, and a grill plate 6 can be placed on the heating base 5. When the heating base 5 and grill plate 6 are installed, the heating base 5 can be powered to heat food on the grill plate 6, realizing a grilling function that is especially suitable for outdoor camping.

According to some embodiment, the functional groove 3 can serve as a storage area for storing various items or food. For example, ice can be placed inside the groove so that it can keep the food or drink chilled.

As shown in FIG. 1, this embodiment of the folding table also has additional storage function. In this embodiment, a storage rack 9 is mounted on the second table body 2, specifically on the outer side of the second table frame 22. The storage rack 9 has an expanded state and a folded state. In the expanded state, the storage rack 9 unfolds outward from the second table frame 22 and provides a storage function. In the folded state, the storage rack 9 is positioned close to the outer side of the second table frame 22.

The storage rack 9 in this embodiment includes a storage platform 90, a first link rod 91, and a second link rod 92. The inner side of the storage platform 90 is rotatably connected to the second table frame 22. A first end of the first link rod 91 is rotatably connected to the outer side of the storage platform 90. A first end of the second link rod 92 is rotatably connected to the second end of the first link rod 91. The second end of the second link rod 92 is rotatably connected to the second table frame 22. The rotation connection point between the second link rod 92 and the second table frame 22 is located above the rotation connection point between the storage platform 90 and the second table frame 22.

In the expanded state of the storage rack 9, the first link rod 91 and the second link rod 92 are aligned along the same axis and are both inclined relative to the horizontal plane. The storage platform 90 is in a horizontal position, and the outer edge of the storage platform 90 is located outside the corresponding edge of the second tabletop 21, allowing users to easily access items on the storage platform 90.

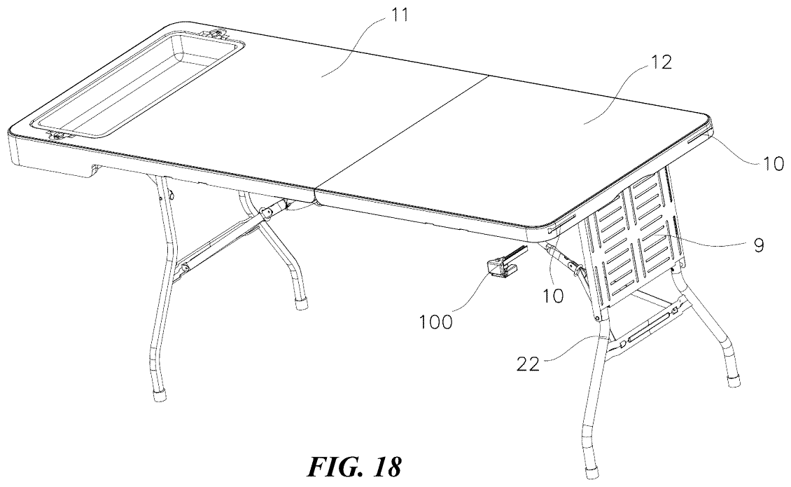

Referring to FIG. 18, in the folded state of the storage rack 9, the storage rack 9 is in a vertical position and close to the second table frame 22. At this state, the storage rack 9 does not occupy external space of the table and has minimal impact on the overall appearance of the table.

### Embodiment II

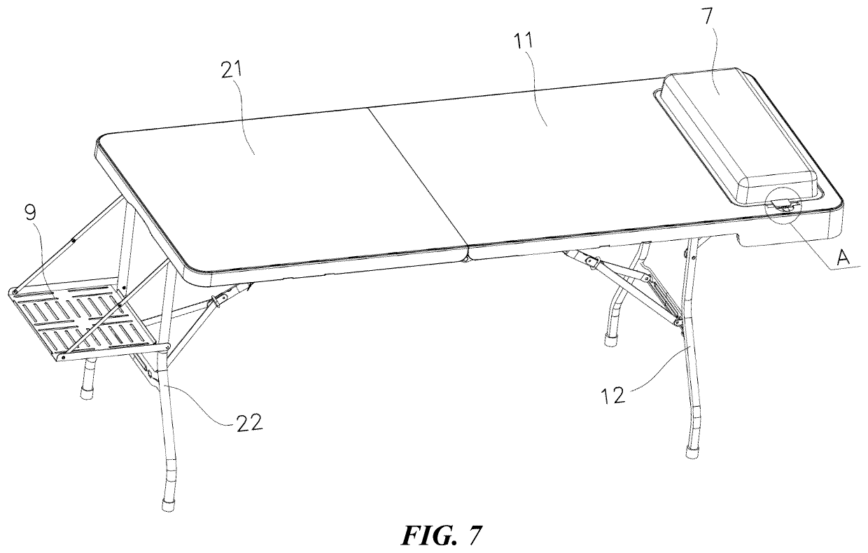

As shown in FIGS. 7 to 13, according to some embodiments, a cover 7 can be mounted above the functional groove 3 of the multifunctional folding table. A locking and limiting structure can be provided between the functional groove 3 and the cover 7. The cover 7 is positionally limited above the functional groove 3 or stored inside the functional groove 3 through the locking and limiting structure.

Specifically, both sides of the cover 7 are provided with outwardly extending limiting blocks 71, and the corresponding sides of the functional groove 3 are formed with limiting notches 31. Lock blocks 8 are mounted on the outer side of the limiting notches 31. The limiting blocks 71 are inserted into the limiting notches 31 and locked in position via the lock blocks 8.

As shown in FIGS. 7 to 9, when the cover 7 is placed above the functional groove 3, the lock blocks 8 are rotated to the outer side of the limiting notches 31, and the root ends of the lock blocks 8 abut the limiting blocks 71, thereby securing the cover 7.

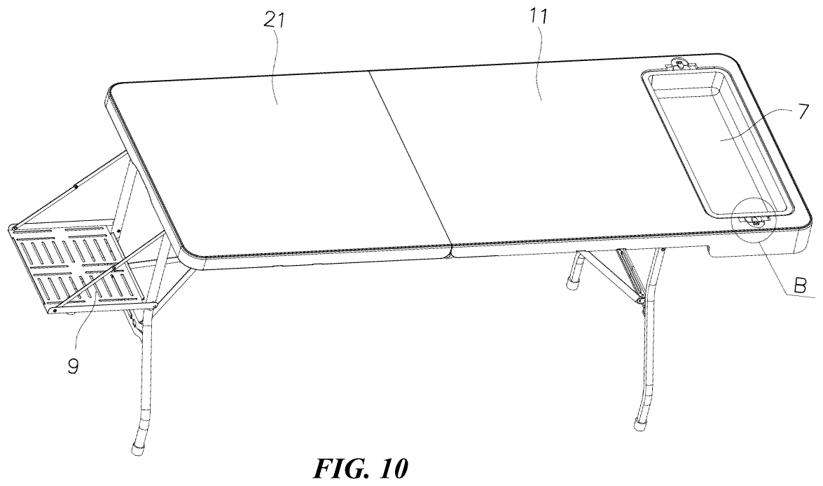

As shown in FIGS. 10 to 13, during storage, the cover 7 can be removed and placed top side down inside the functional groove 3. At this time, the lock blocks 8 are rotated to the inner side of the limiting notches 31 and press down on the limiting blocks 71, thereby securing the cover 7.

Furthermore, the upper surface of the limiting blocks 71 in this embodiment is further provided with protrusions 711, and the lower surface of the lock blocks 8 is provided with recesses (not shown in the drawings). When the lock blocks 8 press down on the limiting blocks 71 to lock them, the protrusions 711 fit into the recesses, providing more reliable locking.

The remaining structure of the multifunctional folding table in this embodiment is the same as that in Embodiment 1 and will not be described further here.

During use of this multifunctional folding table, various items such as beverages or ice can be placed inside the functional groove, and the cover 7 can be placed over it to provide thermal insulation, thereby achieving cooling or preservation functions.

### Embodiment III

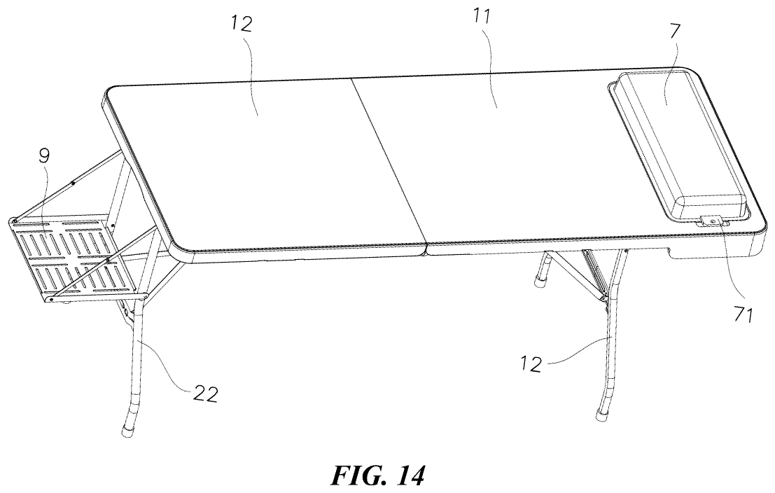

As shown in FIGS. 14 to 16, according to some embodiments, the side portion of the cover 7 of the multifunctional folding table is provided with an outwardly extending positioning block 72. The positioning block 72 is formed with a positioning hole 721. The outer side of the functional groove 3 is formed with a limiting notch 31, and a positioning post 32 extends upward inside the limiting notch 31. The positioning post 32 is inserted into the positioning hole 721 to limit the cover 7 above the functional groove 3.

The remaining structure of the asymmetrical multifunctional folding table in this embodiment is the same as that in Embodiment II and will not be described further here.

### Embodiment IV

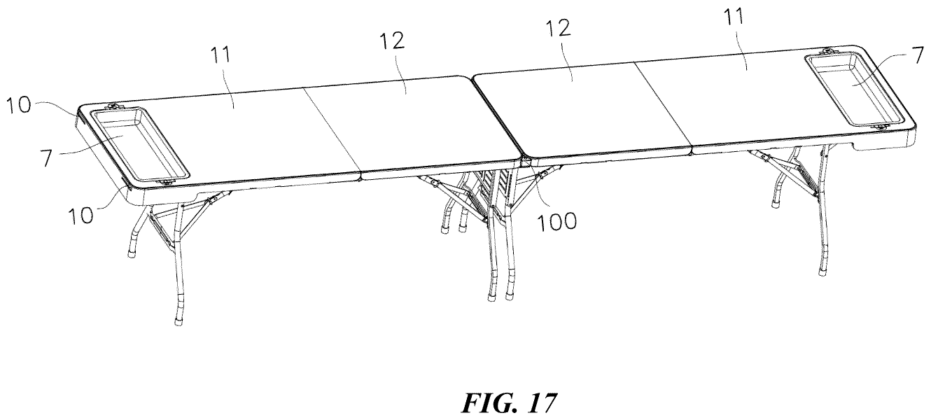

As shown in FIGS. 17 and 18, this embodiment of the multifunctional folding table also has a coupling function, allowing two or more tables to be joined together. According to some embodiments, coupling grooves 10 are formed on the sidewalls of the short edges of both the first tabletop 11 and the second tabletop 21. During coupling, two tables are first brought close together so that the corresponding coupling grooves 10 are aligned. Then, a coupling member 100 is inserted into the two coupling grooves 10 to complete the joining of the two tables, thereby forming a side-by-side coupling structure. In addition, if a short edge of one tabletop is joined to the long edge of another tabletop, a corner-type coupling structure can be formed.

Furthermore, the storage rack structure of the present subject matter is not limited to the structure described in Embodiment 1. Other forms may also be used, such as hanging frames, support racks, etc. The hanging frame and support rack are also detachably connected to the table frame. Trash bags or roll napkins can be hung on the hanging frame, while items such as insulated boxes or snack bags can be placed on the support rack.

In the description and the claims of the present subject matter, directional terms such as “front,” “back,” “top,” “bottom,” “left,” “right,” “side,” “upper,” and “lower” are used to describe various exemplary structural parts and elements of the subject matter. However, these terms are used merely for the purpose of convenient description and are determined based on the orientation shown in the drawings. Since the embodiments disclosed in the present subject matter can be arranged in different orientations, the directional terms are intended for illustrative purposes only and should not be considered limiting. For example, “top” and “bottom” are not necessarily restricted to directions opposite to or aligned with the direction of gravity. Having disclosed exemplary embodiments and the best mode, modifications and variations may be made to the disclosed embodiments while remaining within the scope of the embodiments of the subject matter as defined by the following claims.

What is claimed is:

1. A multifunctional folding table, comprising:
a first table body including a first tabletop and a first table frame disposed beneath the first tabletop; and
a second table body including a second tabletop and a second table frame disposed beneath the second tabletop;
wherein the first and second table bodies are configured to fold relative to each other;
wherein an outer portion of the first tabletop defines a recessed functional groove, the functional groove having an outer bottom surface positioned below a bottom edge of a region of the first tabletop located outside the groove;
wherein a receiving portion is defined between a bottom of the functional groove and the bottom of the region of the first tabletop outside the groove; and
wherein, in a folded state, the second table body is flipped to a back side of the first table body and received within the receiving portion, and a surface of the second tabletop is flush with the outer bottom surface of the functional groove.

2. The multifunctional folding table of claim 1, wherein a length of the second tabletop is equal to a length of the region of the first tabletop outside the functional groove.

3. The multifunctional folding table of claim 1, further comprising:
a first downward flange disposed along an edge of the first tabletop outside the functional groove; and
a second downward flange disposed along an edge of the second tabletop;
wherein the first and second downward flanges have equal height and abut one another when the first and second table bodies are in the folded state.

4. The multifunctional folding table of claim 1, further comprising a heating base installed within the functional groove, and a grill plate positioned on the heating base.

5. The multifunctional folding table of claim 1, further comprising:
a cover positioned above the functional groove; and
a locking and limiting structure disposed between the cover and the functional groove;
wherein the cover is configured to be secured above or stowed within the functional groove via the locking and limiting structure.

6. The multifunctional folding table of claim 5, wherein:
opposing sides of the cover include outwardly extending limiting blocks;
corresponding sides of the functional groove define limiting notches;
lock blocks are mounted on outer sides of the limiting notches; and
the limiting blocks are insertable into the limiting notches and lockable in place via the lock blocks.

7. The multifunctional folding table of claim 6, wherein:
when the cover is placed above the functional groove, the lock blocks are rotatable to an outer side of the limiting notches such that root portions of the lock blocks abut the limiting blocks;
and when the cover is inverted and stowed within the groove, the lock blocks are rotatable to an inner side of the limiting notches and press against the limiting blocks.

8. The multifunctional folding table of claim 5, further comprising:
a positioning block extending outward from a side of the cover, the positioning block defining a positioning hole;
a limiting notch formed on an outer side of the functional groove;
a positioning post extending upward within the limiting notch and configured to engage the positioning hole to secure the cover above the functional groove.

9. The multifunctional folding table of claim 1, further comprising:
a storage rack mounted on an outer side of the first table frame and/or the second table frame;
wherein the storage rack is movable between an expanded state and a folded state;
wherein in the expanded state, the storage rack unfolds outward from the table frame to provide a storage function;
and in the folded state, the storage rack is positioned adjacent to the outer side of the table frame.

10. The multifunctional folding table of claim 1, further comprising:
a coupling groove formed on a side of the tabletop;
wherein coupling grooves on corresponding sides of two folding tables are alignable and configured to receive a coupling member for securing the folding tables together.

11. A multifunctional folding table comprising:
a first table body and a second table body configured to be foldable relative to each other; and
the first table body comprising a first tabletop and a first table frame disposed at a bottom side of the first tabletop;
the second table body comprising a second tabletop and a second table frame disposed at a bottom side of the second tabletop;
wherein an outer portion of the first tabletop includes a functional groove recessed below a top surface of the first tabletop;
wherein a side of the functional groove and a bottom of the portion of the first tabletop outside the groove together define a receiving portion;
wherein in a folded state, the second table body is flipped to a backside of the first table body and is received within the receiving portion, and a surface of the second tabletop is flush with the outer bottom surface of the functional groove.

12. The multifunctional folding table of claim 11, further comprising:
a storage rack mounted on an outer side of the first table frame or the second table frame;
wherein the storage rack is movable between an expanded state and a folded state;
wherein in the expanded state, the storage rack unfolds outward from the table frame to provide a storage function; and in the folded state, the storage rack is positioned adjacent to the outer side of the table frame.

13. The multifunctional folding table of claim 11, further comprising:
a coupling groove formed on a side of the tabletop;
wherein coupling grooves on corresponding sides of two folding tables are alignable and configured to receive a coupling member for securing the folding tables together.

14. A multifunctional folding table comprising:
a first table body and a second table body configured to be foldable relative to each other; and
the first table body comprising a first tabletop;
the second table body comprising a second tabletop, wherein the first tabletop is longer than the second tabletop;
wherein an outer portion of the first tabletop forms a functional groove recessed below a top surface of the first tabletop;
wherein a side of the functional groove and a bottom of the portion of the first tabletop outside the groove together define a receiving portion;
wherein in a folded state, the second table body is flipped to a backside of the first table body and is received within the receiving portion, and a surface of the second tabletop is flush with the outer bottom surface of the functional groove.

15. The multifunctional folding table of claim 14, further comprising:
a storage rack mounted on an outer side of a first table frame;
wherein the storage rack is movable between an expanded state and a folded state.

16. The multifunctional folding table of claim 14, further comprising:
a coupling groove formed on a side of the first tabletop or the second tabletop;
wherein coupling grooves on corresponding sides of two folding tables are alignable and configured to receive a coupling member for securing the folding tables together.
